(19) United States
(12) Patent Application Publication
(10) Pub. No.: US 2023/0412612 A1
(43) Pub. Date: Dec. 21, 2023

(54) LOCATION-BASED ACCESS APPROVAL

(71) Applicant: Stripe, Inc., South San Francisco, CA (US)

(72) Inventor: Kun Qian, Vancouver BC (CA)

(21) Appl. No.: 17/748,420

(22) Filed: May 19, 2022

(51) Int. Cl. H04L 9/40; G06Q 20/40

(52) U.S. Cl. CPC H04L 63/107; H04L 63/20; G06Q 20/4015; G06Q 20/409; H04L 63/108

(57) ABSTRACT

In one aspect, a method of granting geographic-based access authorization, includes storing, with a first processor, an access credential, receiving, with the first processor, travel data for at least one travel plan for a user of the access credential, transmitting, with the first processor, the received travel data to an issuer of the access credential, updating, with a second processor, access rules based on the received travel plans, receiving, by the second processor from the first processor, an access request during travel, authorizing, by the second processor, access to the first processor in accordance with the updated access rules.

### TECHNICAL FIELD

This application relates generally to network security and more specifically, but not exclusively, to enabling network access during user travel.

### BACKGROUND

Often, access to networks and databases may be inadvertently blocked based on the location of a user. For example, U.S.-based users may be inadvertently blocked from accessing a corporate network when traveling overseas as it could appear to a network manager as a hacking attempt originating from overseas. Similarly, a user may be blocked from completing a transaction with a credit card when traveling overseas as it may appear fraudulent.

### BRIEF DESCRIPTION OF THE SEVERAL VIEWS OF THE DRAWINGS

To easily identify the discussion of any particular element or act, the most significant digit or digits in a reference number refer to the figure number in which that element is introduced.

FIG. 1 is a diagrammatic representation of a networked environment in which the present disclosure may be deployed, in accordance with some examples.

FIG. 2 is a diagrammatic representation of a processing environment, in accordance with some examples.

FIG. 3 is a block diagram showing a software architecture within which the present disclosure may be implemented, in accordance with some examples.

FIG. 4 is a diagrammatic representation of a machine in the form of a computer system within which a set of instructions may be executed for causing the machine to perform any one or more of the methodologies discussed herein, in accordance with some examples.

FIG. 5 is a flowchart illustrating a methodology in accordance with some examples.

### DETAILED DESCRIPTION

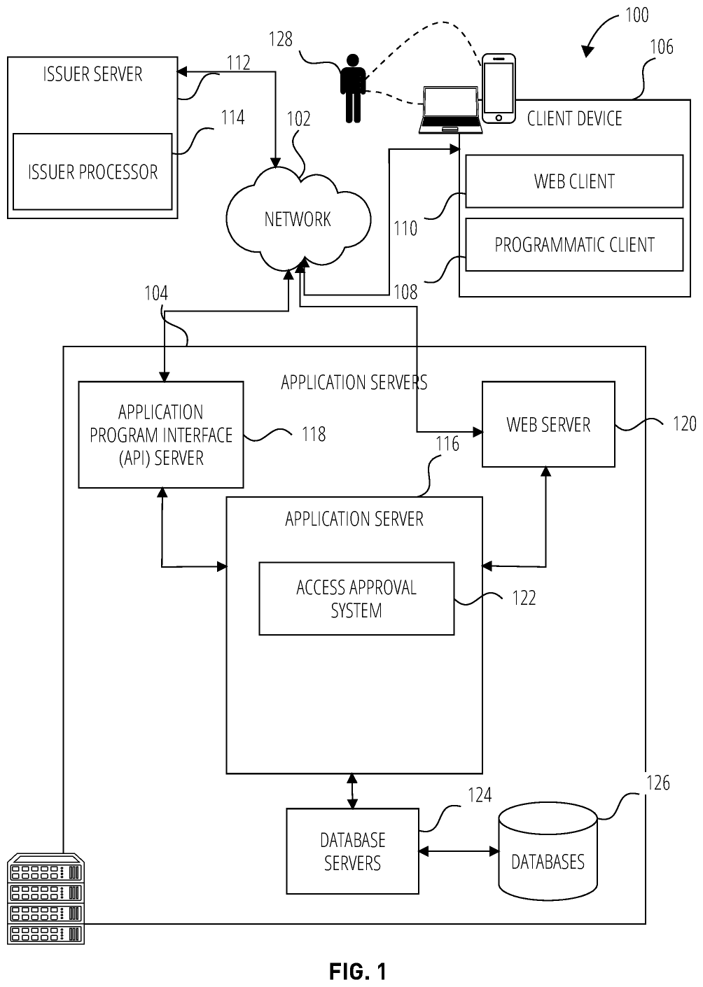

FIG. 1 is a diagrammatic representation of a networked computing environment 100 in which some examples of the present disclosure may be implemented or deployed.

One or more application servers 104 provide server-side functionality via a network 102 to a networked user device, in the form of a client device 106 that is accessed by a user 128. A web client 110 (e.g., a browser) and a programmatic client 108 (e.g., an “app”) are hosted and executed on the web client 110.

An Application Program Interface (API) server 118 and a web server 120 provide respective programmatic and web interfaces to application servers 104. A specific application server 116 hosts an Access approval system 122, which includes components, modules and/or applications.

The web client 110 communicates with the Access approval system 122 via the web interface supported by the web server 120. Similarly, the programmatic client 108 communicates with the Access approval system 122 via the programmatic interface provided by the Application Program Interface (API) server 118.

The application server 116 is communicatively coupled to database servers 124, allowing access to an information storage repository or databases 126. In some examples, the database 126 includes storage devices that store information to be published and/or processed by the Access approval system 122.

Additionally, an issuer processor 114 executing on an issuer server 112, has programmatic access to the application server 116 via the programmatic interface provided by the Application Program Interface (API) server 118. For example, the issuer processor 114, using information retrieved from the application server 116, may enable access to a user while traveling (e.g., use of credit cards in a foreign jurisdiction, access a network, etc.).

A user may have multiple access credentials and credit cards. When traveling, the user needs to notify several banks, network administrators, etc. of her travel plans (traveling outside of a home area, e.g., different city, state, province, country, etc.). Otherwise, she can be locked out of her networks and her credit cards will also be locked. Based on frequent travel, banks and network administrators may learn the user is a frequent traveler and no longer require notification to permit overseas access. However, fraudulent access or credit card charges may occur from overseas, which otherwise would have been blocked.

The access approval system 122 stores all access credentials, including credit cards, network access, etc. and the user sets a default (home) location. Anytime the user travels, she can use the access approval system 122 to inform the issuers (e.g., the issuer processor 114) of the credentials, the dates and location of travel (travel data) so that access is permitted during her travel. For example, the user can enter her travel data to the access approval system 122 using APIs (e.g., from API libraries 324 to make API calls 350) to the issuer processor 114 to notify the issuer processor 114 of the travel data.

Note, there could be a bottleneck if an issuer does the update through an offline job (e.g., takes ˜24 hours). If so, the access approval system 122 can notify the user she needs to update her travel plans at least −24 hours before she leaves. Going forward, the user can rely on the access approval system 122 to manage all her access credentials without worrying about unwanted calls from issuers in the middle of her trip in a stressful manner. Also, banks are more confident about where the user actually is and won't let any offline fraud charges take place to her credit card.

Accordingly, the system 122 enables users to access a network (e.g., work network, financial network for transactions, etc.) while traveling and still prevent unauthorized access to the same while the user is not traveling.

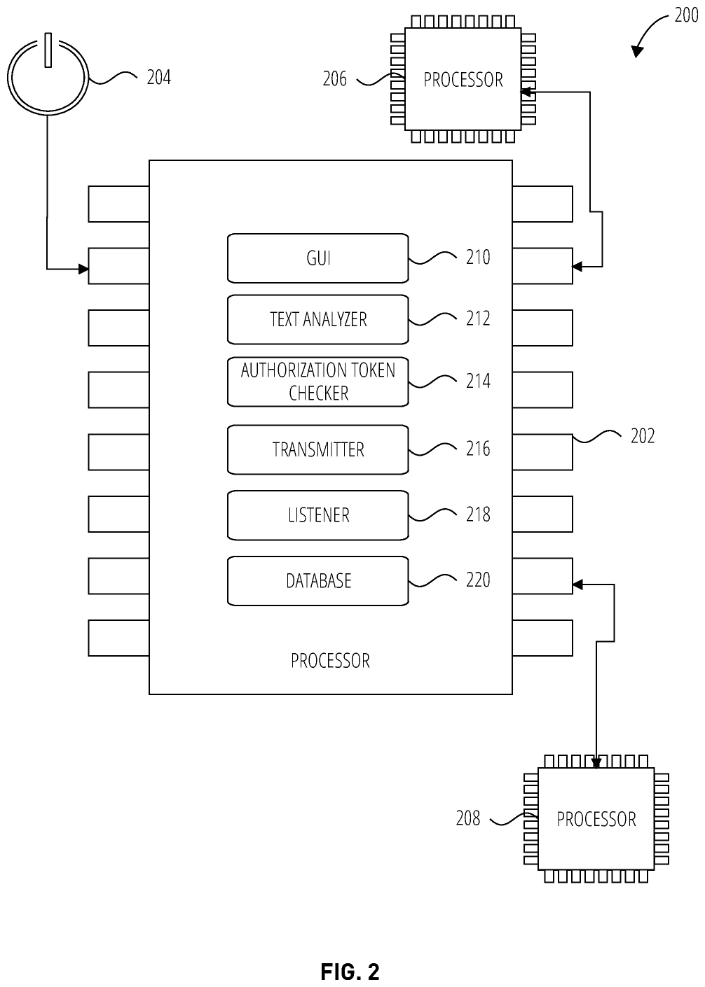

Turning now to FIG. 2, a diagrammatic representation of a processing environment 200 is shown, which includes the processor 206, the Processor 208, and a Processor 202 (e.g., a GPU, CPU, or combination thereof).

The Processor 202 is shown to be coupled to a power source 204, and to include (either permanently configured or temporarily instantiated) modules, namely a graphical user interface GUI 210, an authorization token checker 214, a text analyzer 212, a transmitter 216, a listener 218 and a database 220. The GUI 210 operationally generates a graphical user interface enabling a user to enter her access credentials for storage in the database 220 as well as receiving confirmation that the credential issuers have acknowledged her travel plans. In addition, a user can optionally enter her travel plans with the GUI 210. The authorization token checker 214 operationally checks if any of the credentials have expired and, via the GUI 210, informs the user to update them (e.g., expired credit card). The text analyzer 212 operationally analyzes a message (such as email, text message, etc.) for travel plans in addition to or alternatively to the user entering the plans with the GUI 210. Once travel plans are received and credentials are valid, the transmitter 216 transmits to the issuers the received data of her travel plans (e.g., via APIs to banks, network administrators, etc.). The listener 218 then monitors for confirmation from the issuers and will inform the user, via the GUI 210, of results. If results aren't received from the issuer within a prespecified time confirming acceptance of the travel plans, the listener 218 will follow up with the issuer. The database 220 stores the credentials as well as travel data of her travel plans input via the GUI 210 and/or via the text analyzer 212.

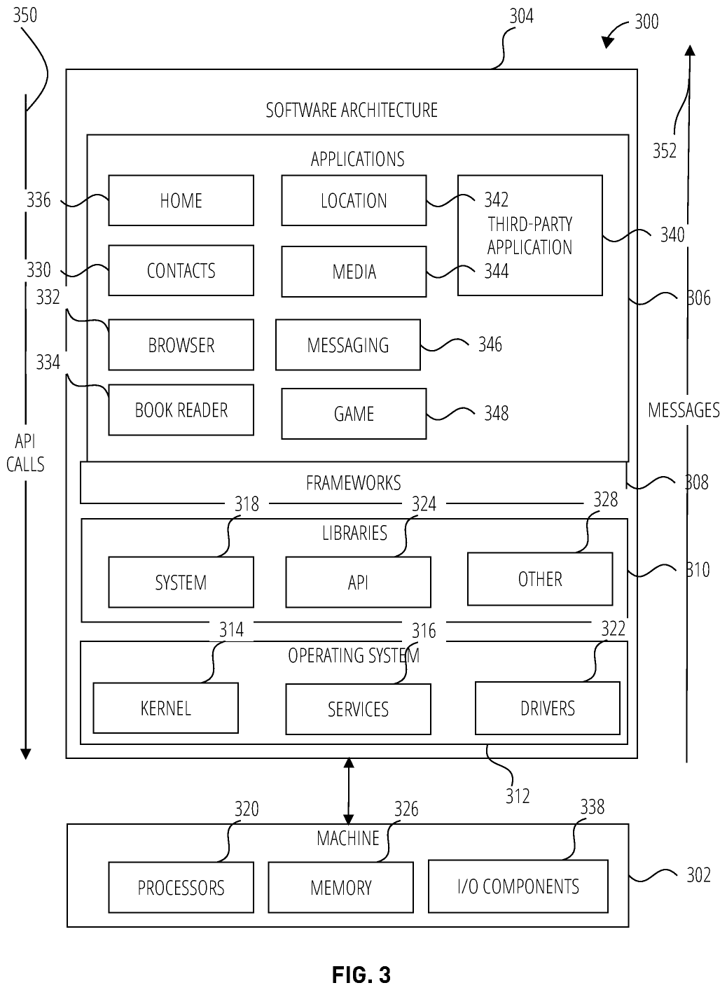

FIG. 3 is a block diagram 300 illustrating a software architecture 304, which can be installed on any one or more of the devices described herein. The software architecture 304 is supported by hardware such as a machine 302 that includes processors 320, memory 326, and I/O components 338. In this example, the software architecture 304 can be conceptualized as a stack of layers, where each layer provides a particular functionality. The software architecture 304 includes layers such as an operating system 312, libraries 310, frameworks 308, and applications 306. Operationally, the applications 306 invoke API calls 350 through the software stack and receive messages 352 in response to the API calls 350.

The operating system 312 manages hardware resources and provides common services. The operating system 312 includes, for example, a kernel 314, services 316, and drivers 322. The kernel 314 acts as an abstraction layer between the hardware and the other software layers. For example, the kernel 314 provides memory management, processor management (e.g., scheduling), component management, networking and security settings, among other functionalities. The services 316 can provide other common services for the other software layers. The drivers 322 are responsible for controlling or interfacing with the underlying hardware. For instance, the drivers 322 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 310 provide a low-level common infrastructure used by the applications 306. The libraries 310 can include system libraries 318 (e.g., C standard library) that provide functions such as memory allocation functions, string manipulation functions, mathematical functions, and the like. In addition, the libraries 310 can include API libraries 324 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 310 can also include a wide variety of other libraries 328 to provide many other APIs to the applications 306.

The frameworks 308 provide a high-level common infrastructure used by the applications 306. For example, the frameworks 308 provide various graphical user interface (GUI) functions, high-level resource management, and high-level location services. The frameworks 308 can provide a broad spectrum of other APIs that can be used by the applications 306, some of which may be specific to a particular operating system or platform.

In some examples, the applications 306 may include a home application 336, a contacts application 330, a browser application 332, a book reader application 334, a location application 342, a media application 344, a messaging application 346, a game application 348, and a broad assortment of other applications such as a third-party application 340. The applications 306 are programs that execute functions defined in the programs. Various programming languages can be employed to create one or more of the applications 306, structured in a variety of manners, such as object-oriented programming languages (e.g., Objective-C, Java, or C++) or procedural programming languages (e.g., C or assembly language). In a specific example, the third-party application 340 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 340 can invoke the API calls 350 provided by the operating system 312 to facilitate functionality described herein.

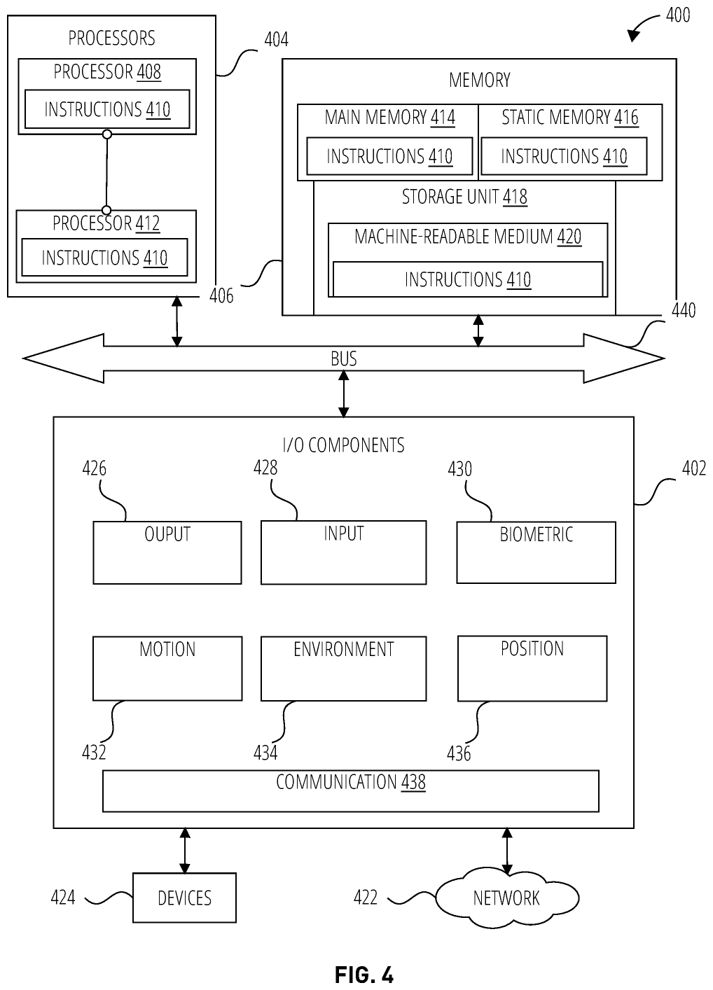

FIG. 4 is a diagrammatic representation of the machine 400 within which instructions 410 (e.g., software, a program, an application, an applet, an app, or other executable code) for causing the machine 400 to perform any one or more of the methodologies discussed herein may be executed. For example, the instructions 410 may cause machine 400 to execute any one or more of the methods described herein. The instructions 410 transform the general, non-programmed machine 400 into a particular machine 400 programmed to carry out the described and illustrated functions in the manner described. The machine 400 may operate as a standalone device or be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while a single machine 400 is illustrated, the term “machine” may include a collection of machines that individually or jointly execute the instructions 410 to perform any one or more of the methodologies discussed herein.

The machine 400 may include processors 404, memory 406, and I/O components 402, which may be configured to communicate via bus 440. In some examples, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 408 and a Processor 412 that execute the instructions 410. The term “Processor” is intended to include multi-core processors that may comprise two or more independent processors (sometimes referred to as “cores”) that may execute instructions contemporaneously. Although FIG. 4 shows multiple processors 404, the machine 400 may include a single processor with a single core, a single processor with multiple cores (e.g., a multi-core processor), multiple processors with a single core, multiple processors with multiples cores, or any combination thereof.

The memory 406 includes a main memory 414, a static memory 416, and a storage unit 418, both accessible to the processors 404 via the bus 440. The main memory 406, the static memory 416, and storage unit 418 store the instructions 410 embodying any one or more of the methodologies or functions described herein. The instructions 410 may also reside, wholly or partially, within the main memory 414, within the static memory 416, within machine-readable medium 420 within the storage unit 418, within the processors 404 (e.g., within the processor's cache memory), or any suitable combination thereof, during execution thereof by the machine 400.

The I/O components 402 may include various components to receive input, provide output, produce output, transmit information, exchange information, or capture measurements. The specific I/O components 402 included in a particular machine depend on the type of machine. For example, portable machines such as mobile phones may include a touch input device or other such input mechanisms, while a headless server machine will likely omit such a touch input device. The I/O components 402 may include many other components not shown in FIG. 4. In various examples, the I/O components 402 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 402 may include biometric components 430, motion components 432, environmental components 434, or position components 436, among a wide array of other components. For example, the biometric components 430 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 432 include acceleration sensor components (e.g., accelerometer), gravitation sensor components, rotation sensor components (e.g., gyroscope). The environmental components 434 include, for example, one or more cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment. The position components 436 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 402 further include communication components 438 operable to couple the machine 400 to a network 422 or devices 424 via respective coupling or connections. For example, the communication components 438 may include a network interface Component or another suitable device to interface with the network 422. In further examples, the communication components 438 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 424 may be another machine or any of a wide variety of peripheral devices (e.g., a peripheral device coupled via a USB).

Moreover, the communication components 438 may detect identifiers or include components operable to detect identifiers. For example, the communication components 438 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D barcode, and other optical codes), or acoustic detection components (e.g., microphones to identify tagged audio signals). In addition, a variety of information may be derived via the communication components 438, such as location via Internet Protocol (IP) geolocation, location via Wi-Fi® signal triangulation, or location via detecting an NFC beacon signal that may indicate a particular location.

The various memories (e.g., main memory 414, static memory 416, and/or memory of the processors 404) and/or storage unit 418 may store one or more sets of instructions and data structures (e.g., software) embodying or used by any one or more of the methodologies or functions described herein. These instructions (e.g., the instructions 410), when executed by processors 404, cause various operations to implement the disclosed examples.

The instructions 410 may be transmitted or received over the network 422, using a transmission medium, via a network interface device (e.g., a network interface component included in the communication components 438) and using any one of several well-known transfer protocols (e.g., hypertext transfer protocol (HTTP)). Similarly, the instructions 410 may be transmitted or received using a transmission medium via a coupling (e.g., a peer-to-peer coupling) to the devices 424.

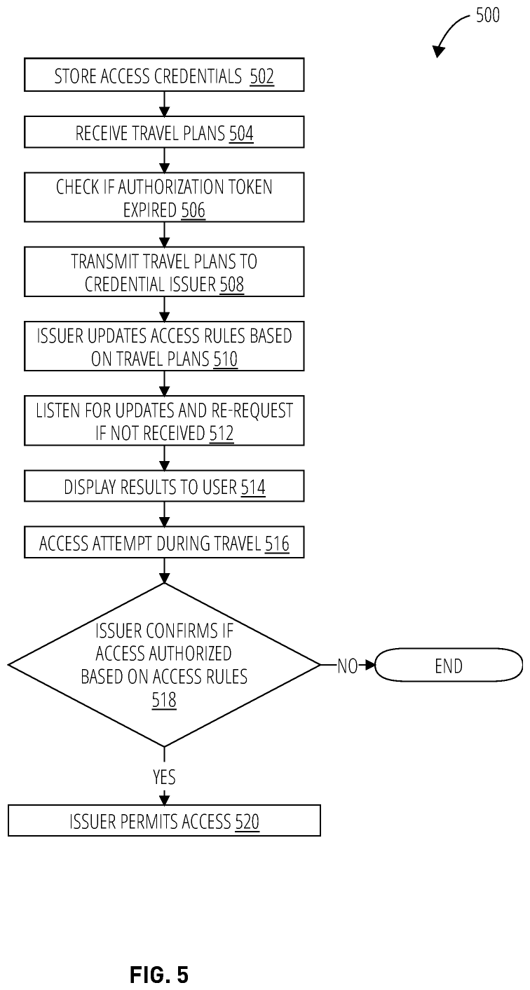

FIG. 5 is a flowchart illustrating a method 500 in accordance with some examples. In block 502, a user enters credentials (e.g., credit cards, network access credentials, etc.) with the GUI 210, which are stored in the database 220 (encrypted in an example). In another aspect, users may have associated user profiles that are stored in the database 220. For example, a user traveling for business may have different access restrictions (spending thresholds, network access, etc.) compared to when the user is traveling for leisure, and such different traveling could involve different sets of cards and payment methods (company issued card versus personal card). Such restrictions can be saved as profiles to be reused by users. In block 504, the access approval system 122 then receives travel data, e.g., via the GUI 210 and/or the text analyzer 212, which are then stored in the database 220. In an example, the text analyzer 212 uses a natural language processor to determine the travel plans based on the received text, which may be an email, text message, etc. In an example, the text analyzer 212 may be granted access to an email system and will analyze all incoming emails automatically for travel plans. In another example, a user can forward an email having travel plans to the text analyzer 212 for analysis. In another example, in addition or in combination, travel plans can be suggested based on a determined location of a user's device. For example, current location can be determined using a geolocation API call and/or checking an IP address of a device. However, a device's geolocation can be misleading in a situation when the device is lost. So users' authorized approvals of suggested locations should still be implemented. Such authorization should be multi-factor authorizations (e.g: 2FA).

In block 506, the authorization token checker 214 checks if an authorization token expired for any of the credentials stored in the database 220, e.g., expired credit card, and requests renewal/update of the same user if needed. Once renewed or updated as needed, in block 508, the transmitter 216 transmits the received travel plans to credential issuer (e.g., bank, network administrator, etc.). Alternatively, the transmission of travel plans to issuers of expired credentials can be skipped without updating/renewing. In block 510, the issuer updates access rules based on transmitted travel data. In block 512, the listener 218 monitors for updates and re-requests approval if not received after a pre-specified amount of time (e.g., 1 hour). In block 514, the GUI 210 displays results to users from the issuers (e.g., accepted, in process, fail, etc.). In block 516, a user then makes an access attempt during travel. In decision block 518, the issuer confirms if access is authorized based on the access rules, and, if authorized, in block 520, the issuer permits access. The access rules may be based on travel plans, locations that are indicated as acceptable by the user, spending thresholds (including different thresholds for different locations), etc. The access rules may be based on the access profile of a user. In another example, the access rules can be developed using machine learning based on past travel data including plans and physical travel as training data.

In an example scenario, a user is visiting Paris next week, he logs onto the access approval system 122 (e.g., via an app, web browser, etc.), and sees a list of the credentials (e.g., credit cards and/or network credentials, etc.). He clicks on all the credentials that he would like to update.

The access approval system 122 checks if all credentials are still valid (no credit card expired, no payment methods' authorization tokens expired, no network access credential expired), which can include validating the credentials with the issuers (e.g., if no expiration is associated with the stored credentials in the database 220). If anything is expired, the GUI 210 can prompt the user to update card information, re-authenticate payment methods, etc. If nothing expired, the transmitter 216 proceeds to send this update to all issuers (e.g., financial institutions) using APIs. This API will expect to return “success”, “failure” (service down, timed-out . . . ), or “expected to be updated at xxx time” if their financial institutions perform this update through a batched job. Note that anything failed in this step should be a service error from the financial institution's side, instead of a user's incurred error because authorization token checker 214 already validated clients' inputs with the issuers. If it is possible to have any clients' incurred errors in this step (even though there should not be), the GUI 210 will surface this (e.g., “your request was declined by ABC bank because . . . ”).

The access approval system 122 returns the results to the user, and marks all successful updates for users, and sets an expectation for when the other ones will be updated (“to be updated on xxx time, check back later”). The listener 218 then tracks the timeline to retry the failed ones. The listener 218 further periodically checks for updates through API calls to financial institutions based on the estimates they provide, or asks them to notify the listener 218 through an API interface when they are done.

Notifications can be push notifications or pull every few hours for updates, or a combination of both. The client can receive updates/push notifications when any update is successful. When the user logs on (via an app, web browser, etc.) to the access approval system 122, the access approval system 122 will send an API call to check the status for all of the requested updates, and the access approval system 122 checks in the database 220 or cache and returns a list of results to the user via the GUI 210. If the user's trip is canceled or rescheduled, he/she can make changes via the GUI 210, and the access approval system 122 will handle everything accordingly (cancel in-progress requests and/or invalidate successful requests).

The following examples describe various embodiments of methods, machine-readable media, and systems (e.g., machines, devices, or other apparatus) discussed herein.

A method of granting geographic-based access authorization, the method comprising:
storing, by a first hardware processor, an access credential;
receiving, by the first hardware processor, travel data comprising one or more travel plans for a user of the access credential;
transmitting, by the first hardware processor, the received travel data to an issuer of the access credential;
updating, by a second hardware processor corresponding to the issuer, access rules based on the received travel data;
receiving, by the second hardware processor from the first processor, an access request during a first time period;
determining, by the second hardware processor, based on the updated access rules, that an access to the first processor during the first time period is authorized; and
in response to the determining, authorizing, by the second hardware processor, access to the first processor.

2. The method of example 1, wherein the receiving, with the first hardware processor, travel data includes converting, with a natural language processor, an email holding travel information into the travel data.

3. The method of any of the preceding examples, further comprising accessing an email account of the user to retrieve the email.

4. The method of any of the preceding examples, wherein the receiving, with the first hardware processor, travel data for a user of the access credential comprises receiving the travel data via a graphical user interface.

5. The method of any of the preceding examples, wherein the access request includes requesting access to a network.

6. The method of any of the preceding examples, wherein the access request includes completing a transaction with a credit card.

7. The method of any of the preceding examples, further comprising, before the transmitting, with the first hardware processor, the received travel data, checking if an authorization token for the stored credential has expired.

8. The method of any of the preceding examples, further comprising blocking, by the second hardware processor, access based on the user being located within a predefined home geography during a travel period per the travel plans.

9. The method of any of the preceding examples, further comprising transmitting, with the first hardware processor, canceled travel plans to the issuer processor, and updating, with the second processor, the access rules accordingly.

10. A non-transitory computer-readable storage medium, the computer-readable storage medium including instructions that when executed by a computer, cause the computer to perform operations comprising:
storing an access credential;
receiving travel data comprising one or more travel plans for a user of the access credential; transmitting the received travel data to an issuer of the access credential thereby causing a processor associated with the issuer to perform operations comprising;
updating access rules based on the received travel data;
receiving, from the computer, an access request during a first time period;
determining based on the updated access rules, that an access to the computer during the first time period is authorized; and in response to the determining, authorizing access to the computer.

11. A computing apparatus comprising:
at least one processor; and at least one memory storing instructions that, when executed by the at least one processor, configure the apparatus to:
store an access credential;
receive travel data comprising one or more travel plans for a user of the access credential; transmitting the received travel data to an issuer of the access credential thereby causing a processor associated with the issuer to perform operations comprising;
updating access rules based on the received travel data;
receiving, from the computing apparatus, an access request during a first time period; determining based on the updated access rules, that an access to the computing apparatus during the first time period is authorized; and in response to the determining, authorizing access to the computing apparatus.

12. The computing apparatus of any of the preceding examples, wherein the receiving, with the least one processor, travel data includes converting, with a natural language processor, an email holding travel information into the travel plans.

13. The computing apparatus of any of the preceding examples, further comprising accessing an email account of the user to retrieve the email.

14. The computing apparatus of any of the preceding examples, wherein the receiving, with the at least one processor, travel data for a user of the access credential comprises receiving the travel data via a graphical user interface.

15. The computing apparatus of any of the preceding examples, wherein the access request includes requesting access to a network.

16. The computing apparatus of any of the preceding examples, wherein the access request includes completing a transaction with a credit card.

17. The computing apparatus of any of the preceding examples, further comprising, before the transmitting, with the at least one processor, the received travel data, checking if an authorization token for the stored credential has expired.

18. The computing apparatus of any of the preceding examples, further comprising blocking, by the processor associated with the issuer, access if the user is located within a home geography during a travel period per the travel data.

19. The computing apparatus of any of the preceding examples, further comprising transmitting, with the at least one processor, canceled travel plans to the processor associated with the issuer, and updating, with the processor associated with the issuer, the access rules based on the canceled travel plans.

### Glossary

“Carrier Signal” refers to any intangible medium capable of storing, encoding, or carrying instructions for execution by the machine, and includes digital or analog communications signals or other intangible media to enable communication of such instructions. Instructions may be transmitted or received over a network using a transmission medium via a network interface device.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner In examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. A decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of methods described herein may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In some examples, the processors or processor-implemented components may be distributed across a number of geographic locations.

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine-Storage Medium” refers to a single or multiple storage devices and/or media (e.g., a centralized or distributed database, and/or associated caches and servers) that store executable instructions, routines and/or data. The term includes solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium”, “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Module” refers to logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, 567574 at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal Medium” refers to any intangible medium that is capable of storing, encoding, or carrying the instructions for execution by a machine and includes digital or analog communications signals or other intangible media to enable communication of software or data. The term “signal medium” may omit any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

What is claimed is:

1. A method of granting geographic-based access authorization, the method comprising:
storing, by a first hardware processor, an access credential;
receiving, by the first hardware processor, travel data comprising one or more travel plans for a user of the access credential;
transmitting, by the first hardware processor, the received travel data to an issuer of the access credential;
updating, by a second hardware processor corresponding to the issuer, access rules based on the received travel data;
receiving, by the second hardware processor from the first processor, an access request during a first time period;
determining, by the second hardware processor, based on the updated access rules, that an access to the first processor during the first time period is authorized; and
in response to the determining, authorizing, by the second hardware processor, access to the first processor.

2. The method of claim 1, wherein the receiving, with the first hardware processor, travel data includes converting, with a natural language processor, an email holding travel information into the travel data.

3. The method of claim 2, further comprising accessing an email account of the user to retrieve the email.

4. The method of claim 1, wherein the receiving, with the first hardware processor, travel data for a user of the access credential comprises receiving the travel data via a graphical user interface.

5. The method of claim 1, wherein the access request includes requesting access to a network.

6. The method of claim 1, wherein the access request includes completing a transaction with a credit card.

7. The method of claim 1, further comprising, before the transmitting, with the first hardware processor, the received travel data, checking if an authorization token for the stored credential has expired.

8. The method of claim 1, further comprising blocking, by the second hardware processor, access based on the user being located within a predefined home geography during a travel period per the travel plans.

9. The method of claim 1, further comprising transmitting, with the first hardware processor, canceled travel plans to the issuer processor, and updating, with the second processor, the access rules accordingly.

10. A non-transitory computer-readable storage medium, the computer-readable storage medium including instructions that when executed by a computer, cause the computer to perform operations comprising:
storing an access credential;
receiving travel data comprising one or more travel plans for a user of the access credential;
transmitting the received travel data to an issuer of the access credential thereby causing a processor associated with the issuer to perform operations comprising;
updating access rules based on the received travel data;
receiving, from the computer, an access request during a first time period;
determining based on the updated access rules, that an access to the computer during the first time period is authorized; and
in response to the determining, authorizing access to the computer.

11. A computing apparatus comprising:
at least one processor; and
at least one memory storing instructions that, when executed by the at least one processor, configure the apparatus to:
store an access credential;
receive travel data comprising one or more travel plans for a user of the access credential;
transmitting the received travel data to an issuer of the access credential thereby causing a processor associated with the issuer to perform operations comprising:
updating access rules based on the received travel data;
receiving, from the computing apparatus, an access request during a first time period;
determining based on the updated access rules, that an access to the computing apparatus during the first time period is authorized; and
in response to the determining, authorizing access to the computing apparatus.

12. The computing apparatus of claim 11, wherein the receiving, with at least one processor, travel data includes converting, with a natural language processor, an email holding travel information into the travel plans.

13. The computing apparatus of claim 12, further comprising accessing an email account of the user to retrieve the email.

14. The computing apparatus of claim 11, wherein the receiving, with the at least one processor, travel data for a user of the access credential comprises receiving the travel data via a graphical user interface.

15. The computing apparatus of claim 11, wherein the access request includes requesting access to a network.

16. The computing apparatus of claim 11, wherein the access request includes completing a transaction with a credit card.

17. The computing apparatus of claim 11, further comprising, before the transmitting, with the at least one processor, the received travel data, checking if an authorization token for the stored credential has expired.

18. The computing apparatus of claim 11, further comprising blocking, by the processor associated with the issuer, access if the user is located within a home geography during a travel period per the travel data.

19. The computing apparatus of claim 11, further comprising transmitting, with the at least one processor, canceled travel plans to the processor associated with the issuer, and updating, with the processor associated with the issuer, the access rules based on the canceled travel plans.
